(19) United States
(12) Patent Application Publication
(10) Pub. No.: US 2026/0087563 A1
(43) Pub. Date: Mar. 26, 2026

(54) SYSTEM AND METHOD TO AUTO DETECT TAX SITUATION AND POTENTIAL DEDUCTIONS USING GENAI

(71) Applicant: INTUIT INC., Mountain View, CA (US)

(72) Inventors: John SAMUEL, Bangalore (IN); Sandeep MEWARA, Bangalore (IN); Sanjay KUMAR, Bangalore (IN); Srivathsal V, Bangalore (IN)

(73) Assignee: INTUIT INC., Mountain View, CA (US)

(21) Appl. No.: 18/896,586

(22) Filed: Sep. 25, 2024

(51) Int. Cl. G06Q 40/12; G06F 40/279

(52) U.S. Cl. CPC G06Q 40/123; G06F 40/279

(57) ABSTRACT

A system for automated tax return analysis that streamlines the process of examining and optimizing tax returns. The system employs a partial tax return interpretation engine that uses natural language processing to analyze tax data from multiple years. This data is fed into a genAI module, which compares the processed information and identifies changes over time. The system's knowledge store, containing up-to-date tax rules, works in tandem with a tax situation identifier to cross-reference the detected changes and pinpoint relevant tax situations. Based on these findings, a deductions identifier determines applicable tax deductions. A report generator produces a human-readable document outlining the detected tax situations and potential deductions.

### BACKGROUND

Tax return preparation and analysis have traditionally been complex and time-consuming processes, often requiring manual effort from accountants and tax professionals. In recent years, various software solutions have emerged to assist in tax preparation, offering features such as data entry automation, basic error checking, and simple comparisons between tax years. These tools have helped streamline some aspects of tax return preparation and have become widely adopted by both individual taxpayers and tax professionals.

However, existing tax preparation software often falls short in providing comprehensive, personalized analysis of tax situations and potential deductions. Many systems rely on rule-based algorithms that may not capture the nuances of individual tax situations or fail to identify less obvious deduction opportunities. Additionally, the interpretation of unstructured or partial tax return data remains a challenge, leading to potential inaccuracies or missed insights, which are undesirable.

### SUMMARY

Embodiments disclosed herein solve the aforementioned technical problems and may provide other technical solutions as well. Contrary to conventional techniques, the disclosed solution includes a novel method and system to auto detect tax situation and potential deductions using generative artificial intelligence (genAI).

An example embodiment includes a system for automated tax return analysis, comprising a partial tax return interpretation engine configured to execute natural language processing to process tax return data from two or more tax years, a genAI module configured to compare the processed tax return data and identify changes between the two or more tax years, a knowledge store containing tax rules, a tax situation identifier configured to cross-reference the identified changes with the tax rules to detect tax situations, a deductions identifier configured to determine tax deductions based on the detected tax situations, and a report generator configured to produce a human-readable report of the detected tax situations and the tax deductions.

Another example embodiment includes a method for automated tax return analysis, comprising executing, by a partial tax return interpretation engine, natural language processing to process tax return data from two or more tax years, comparing, by a genAI module, the processed tax return data and identifying changes between the two or more tax years, storing, in a knowledge store, tax rules, cross-referencing, by a tax situation identifier, the identified changes with the tax rules to detect tax situations, determining, by a deductions identifier, tax deductions based on the detected tax situations, and producing, by a report generator, a human-readable report of the detected tax situations and the tax deductions.

### BRIEF DESCRIPTION OF THE DRAWINGS

So that the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may apply to other equally effective example embodiments.

FIG. 1 illustrates a system for automated tax return analysis, according to aspects of the present disclosure.

FIG. 2 depicts an automated tax analysis system, in accordance with example embodiments.

FIG. 3 shows a flowchart of a process for automated tax return analysis using genAI, according to an embodiment.

FIG. 4 illustrates a flowchart for a process of interpreting partial tax return data, according to aspects of the present disclosure.

FIG. 5 depicts a flowchart for a process of analyzing tax returns using genAI, in accordance with example embodiments.

FIG. 6 shows a flowchart for a process of validating and optimizing tax deductions, according to an embodiment.

FIG. 7 illustrates a flowchart for a feedback loop process in an automated tax return analysis system, according to aspects of the present disclosure.

FIG. 8 depicts a system diagram of a computing system, in accordance with example embodiments.

### DETAILED DESCRIPTION OF SEVERAL EMBODIMENTS

Various example embodiments of the present disclosure will now be described in detail with reference to the drawings. It should be noted that the relative arrangement of the components and steps, the numerical expressions, and the numerical values set forth in these example embodiments do not limit the scope of the present disclosure unless it is specifically stated otherwise. The following description of at least one example embodiment is merely illustrative in nature and is in no way intended to limit the disclosure, its application, or its uses. Techniques, methods, and apparatuses as known by one of ordinary skill in the relevant art may not be discussed in detail but are intended to be part of the specification where appropriate. In the examples illustrated and discussed herein, any specific values should be interpreted to be illustrative and non-limiting. Thus, other example embodiments may have different values. It is noted that similar reference numerals and letters refer to similar items in the figures, and once an item is defined for one figure, it is possible that it need not be further discussed for the other figures.

The present disclosure relates to an automated system and method for tax return analysis. This system and method leverage advanced technologies, such as generative artificial intelligence (genAI) and natural language processing (NLP), to analyze and compare partial tax returns from two or more years. The system and method are designed to identify tax situations and potential deductions, thereby addressing the challenges associated with manual tax return preparation and analysis, which can be time-consuming, error-prone, and complex.

The disclosed system and method provide personalized tax return comparisons, identify inconsistencies, suggest optimizations, and generate actionable recommendations based on historical data and current tax laws. This significantly enhances the tax planning and preparation process for both taxpayers and accountants, offering a more efficient, accurate, and cost-effective solution.

Components of the system include a “partial tax return” interpretation engine, a genAI system, a knowledge store, and a feedback loop. The “partial tax return” interpretation engine employs advanced NLP algorithms to interpret and structure tax return data. The genAI System uses generative models to generate human-readable comparisons between tax years. The knowledge store utilizes a vector store for rapid retrieval and application of tax rules. The feedback Loop incorporates reinforcement learning to continuously improve the system's performance.

Together, these components enable the disclosed system to provide personalized tax return comparisons, identify inconsistencies, suggest optimizations, and generate actionable recommendations based on historical data and current tax laws. This enhances the tax planning and preparation process for both taxpayers and accountants, offering a more efficient, accurate, and cost-effective solution.

For clarity and example purposes only, consider a use case example where the automated tax situation and deduction detection system may be employed by a small business owner who runs a home-based graphic design company. The small business owner has been managing her own taxes for the past few years but has found the process increasingly complex as her business has grown. She decides to use the automated system to analyze her tax returns from the previous two years and gain insights for the current tax year.

The small business owner uploads her partial tax returns from the past two years into the system. The partial tax return interpretation engine uses NLP to interpret and structure the data from these returns, even though some information may be missing or incomplete. The genAI module compares the processed tax return data and identifies changes between the two years, such as an increase in business income and new equipment purchases.

The tax situation identifier cross-references these identified changes with the tax rules stored in the knowledge store. It detects several relevant tax situations, including the potential for a home office deduction and depreciation of newly purchased equipment. The deductions identifier determines specific tax deductions based on these detected situations, calculating the appropriate amounts for the home office deduction and equipment depreciation.

The report generator produces a human-readable report for the small business owner, outlining the detected tax situations and recommended deductions. The report highlights the increase in her business income, suggests claiming a home office deduction, and provides guidance on how to depreciate her new equipment purchases. It also identifies a missed opportunity from the previous year where the small business owner could have claimed a deduction for professional development courses she attended.

The solution will now be described in greater detail with reference to the accompanying figures, which illustrate various aspects and embodiments of the automated tax situation and deduction detection system using genAI. These figures provide visual representations of the system's components, processes, and workflows, offering a comprehensive overview of the disclosed structure and functionality. The following detailed description, in conjunction with the figures, will provide a thorough understanding of the disclosed features, advantages, and potential applications in the field of tax return analysis and preparation.

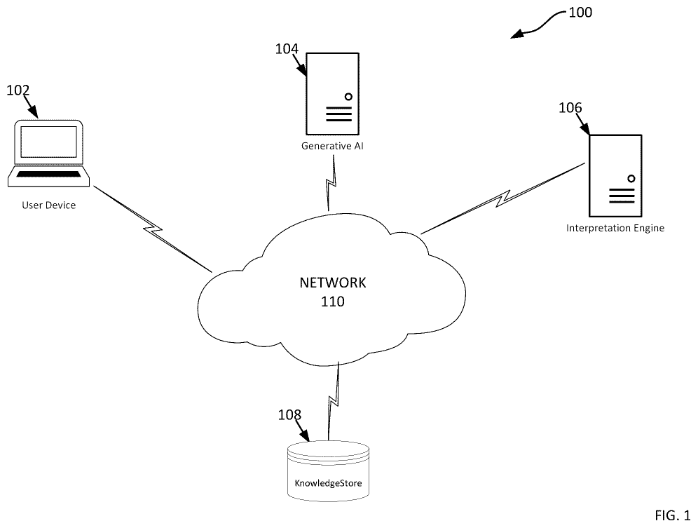

Referring to FIG. 1, a system 100 for automated tax return analysis is now described. The system 100 includes several interconnected components that communicate through a network cloud 110. A user device 102, such as a laptop computer, smartphone, or tablet, is connected to the network cloud 110. The user device 102 may be used by a taxpayer or an accountant to input tax return data into the system 100. The user device 102 may include a user interface, such as a web browser or a dedicated application, through which the user can interact with the system 100.

The network cloud 110 facilitates communication between the user device 102 and other components of the system 100. The network cloud 110 may represent a variety of network types, including local area networks (LANs), wide area networks (WANs), the internet, or a combination thereof. In some cases, the network cloud 110 may include servers or other computing resources that provide additional processing power or storage capacity for the system 100.

Connected to the network cloud 110 is a genAI module 104, depicted as a server device, which processes data and generates insights. The genAI module 104 may include machine learning algorithms, such as generative adversarial networks (GANs) or variational autoencoders (VAEs), to analyze and compare tax return data. The genAI module 104 may generate human-readable comparisons between tax returns from different years, identify changes in income or expenses, and suggest potential deductions based on these comparisons.

An interpretation engine 106, depicted as a server device, is also linked to the network cloud 110. The interpretation engine 106 is responsible for interpreting and analyzing tax return data. The interpretation engine 106 may use advanced NLP algorithms, such as Bidirectional Encoder Representations from Transformers (BERT), Generative Pre-Trained Transformer (GPT), to interpret and structure the tax return data. This allows the system 100 to handle both complete and partial tax returns, and to work with unstructured or semi-structured data.

The system 100 also includes a knowledge store 108, depicted as a database, which is connected to the network cloud 110. The knowledge store 108 stores relevant tax rules and regulations. The knowledge store 108 may use a vector store or other data structure to enable rapid retrieval and application of tax rules. The knowledge store 108 may be updated regularly to ensure that the system 100 is working with the current tax laws and regulations.

In operation, a user uploads partial tax returns for two or more years to the system 100 via the user device 102. The interpretation engine 106 processes and structures the data from the uploaded returns. The genAI module 104 compares the processed tax return data and identifies changes between the two or more tax years. The knowledge store 108 cross-references the identified changes with current tax laws to detect tax situations and potential deductions. The system 100 then generates a comprehensive, human-readable report highlighting the detected tax situations and potential deductions, which the user can review and implement.

In some aspects, the genAI module 104, interpretation engine 106, and knowledge store 108 may reside on one or more servers connected to the network cloud 110. These components may be distributed across multiple servers to enhance processing power and system reliability. In some examples, however, the genAI module 104, interpretation engine 106, and knowledge store 108 may reside on the same server, which may be beneficial for smaller-scale implementations or when optimizing for reduced latency in data processing and retrieval. The specific configuration may depend on factors such as system requirements, expected user load, and available computing resources.

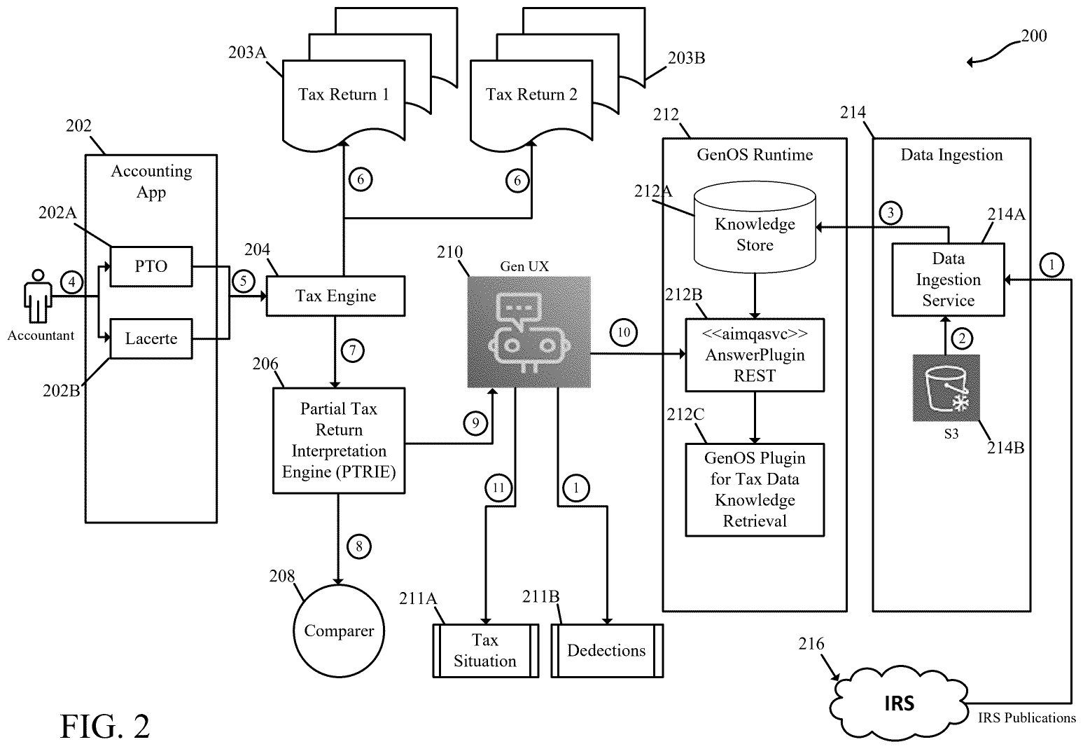

Referring to FIG. 2, a system 200 for automated tax return analysis is now described. The system 200 is a detailed version of the functions being performed on the devices in FIG. 1 and includes several interconnected components that work together to process, analyze, and compare tax return data. The system 200 is designed to identify tax situations and potential deductions, providing personalized insights and recommendations to users.

The system 200 includes an accountant interface 202, which may be a graphical user interface or a command-line interface that allows an accountant or a user to interact with the system 200. The accountant interface 202 may include various software applications, such as PTO software 202A and Lacerte software 202B, which are used for tax preparation and filing. These software applications may be used to input tax return data into the system 200, view the results of the tax return analysis, and implement the suggested changes.

The system 200 processes tax return data from two or more tax years, represented as tax return 1 203A and tax return 2 203B. The tax return data may be in the form of complete or partial tax returns, and may include information about the taxpayer's income, expenses, deductions, credits, and other relevant tax information. The tax return data may be input into the system 200 through the accountant interface 202 or may be automatically retrieved from a database or other data source.

In some aspects, the system 200 may be capable of analyzing tax returns from consecutive or non-consecutive years, providing flexibility in the comparison process. This feature allows users to compare tax situations across different time periods, which can be particularly useful for identifying long-term trends, assessing the impact of significant life events or business changes, or analyzing the effects of changes in tax laws over time. By accommodating both consecutive and non-consecutive year comparisons, the system enhances its utility for a wider range of tax planning and analysis scenarios.

The tax return data is processed by a tax engine 204, which is configured to execute various tax calculations and generate a tax return. The tax engine 204 may use various tax rules and regulations to calculate the taxpayer's tax liability, determine the amount of tax owed or refund due, and generate a tax return that complies with the applicable tax laws.

The processed tax return data is then analyzed by a partial tax return interpretation engine 206. The partial tax return interpretation engine 206 is configured to execute NLP algorithms to interpret and structure the tax return data. The NLP algorithms may include transformer-based models like BERT and GPT, which are capable of understanding the context and semantics of the tax return data, even when the data is incomplete or unstructured. The partial tax return interpretation engine 206 outputs structured tax data that can be easily compared with other tax data.

The structured tax data is compared by a comparer 208, which is part of a genAI module. The comparer 208 uses generative models, such as GANs or VAEs, to generate a human-readable comparison of the tax returns from the two or more tax years. The comparer 208 identifies changes in income, expenses, and potential deductions, and generates a comparison result that highlights these changes.

The comparison result is processed by a gen UX module 210, which interfaces with a tax situation identifier 211A and a deductions identifier 211B. The tax situation identifier 211A cross-references the identified changes with the tax rules stored in a knowledge store to detect tax situations. The deductions identifier 211B determines potential tax deductions based on the detected tax situations. The gen UX module 210 generates a human-readable report that includes the detected tax situations and the potential deductions.

The system 200 also includes a GenOS runtime module 212, which includes a knowledge store 212A, an AnswerPlugin REST 212B, and a GenOS plugin for tax data retrieval 212C. The knowledge store 212A stores tax rules, which are used by the tax situation identifier 211A and the deductions identifier 211B to validate the identified changes and deductions. The AnswerPlugin REST 212B and the GenOS plugin for tax data retrieval 212C provide interfaces for retrieving and processing tax-related information from external sources.

The system 200 further includes a data ingestion module 214, which retrieves and processes tax-related information from external sources. The data ingestion module 214 includes an IRS publications data service 214A and S3 storage 214B, which store and provide access to various tax publications and data. The system 200 also interfaces with an IRS interface 216, which provides access to IRS databases and services for retrieving tax-related information. This feature allows the system 200 to incorporate the up-to-date tax information and regulations into its analysis, ensuring that its recommendations are in line with the latest tax laws.

More specifically, the IRS publications data service 214A may provide access to various tax publications, such as tax forms, instructions, and guides, which can be used to interpret and analyze the tax return data. The S3 storage 214B may store tax-related data, such as historical tax return data, tax rules, and regulations, which can be used by the system 200 for comparison and analysis. The knowledge store 212A, which is part of the GenOS runtime 212, stores tax rules. The tax rules may include information about income tax rates, tax brackets, deductions, credits, and other relevant tax laws and regulations. The knowledge store 212A may use a vector store or other data structure to enable rapid retrieval and application of tax rules. The knowledge store 212A may be updated regularly to ensure that the system 200 is working with the current tax laws and regulations. The tax situation identifier 211A and the deductions identifier 211B use the tax rules stored in the knowledge store 212A to validate the identified changes and deductions.

In operation, a user or an accountant inputs tax return data for two or more tax years into the system 200 through the accountant interface 202. The tax engine 204 processes the tax return data and generates a tax return. The partial tax return interpretation engine 206 interprets and structures the tax return data, and the comparer 208 compares the structured tax data and identifies changes. The tax situation identifier 211A and the deductions identifier 211B detect tax situations and potential deductions based on the identified changes. The gen UX module 210 generates a human-readable report that includes the detected tax situations and the potential deductions. The user or the accountant can review the report and implement the suggested changes. The system 200 may also include a feedback loop (not shown in FIG. 2) that captures user actions and refines the system's algorithms based on these actions, allowing the system 200 to learn and improve over time.

The system 200 further includes a report generator, which is part of the gen UX module 210. The report generator is configured to produce a human-readable report of the detected tax situations and the potential deductions. The report may include a comparison of the tax returns from the two or more tax years, highlighting the changes in income, expenses, and potential deductions. The report may also include suggestions for optimizing the taxpayer's tax situation, such as claiming missed deductions or adjusting income or expenses. In some cases, the report may be personalized to the taxpayer's specific situation, providing tailored insights and recommendations based on the taxpayer's income, expenses, life events, and other relevant factors.

In operation, the data ingestion module 214 retrieves tax-related information from the IRS publications data service 214A and the S3 storage 214B. The partial tax return interpretation engine 206 interprets and structures the retrieved data. The comparer 208 compares the structured tax data and identifies changes. The tax situation identifier 211A and the deductions identifier 211B detect tax situations and potential deductions based on the identified changes. The gen UX module 210 generates a human-readable report that includes the detected tax situations and the potential deductions. The user or the accountant can then review the report and implement the suggested changes.

System 200 is capable of handling both complete and partial tax returns. This flexibility allows users to benefit from the analysis even when they have incomplete information, making it particularly useful for preliminary assessments or situations where full documentation is not immediately available. The partial tax return interpretation engine 206 uses advanced NLP algorithms to interpret and structure the data from the tax returns, regardless of their completeness. This enables the system 200 to work with a wide range of tax return data and accommodate various user scenarios.

The system 200 is also capable of identifying specific tax situations, such as rental property depreciation or charitable donations. For example, if a taxpayer owns a rental property, the system 200 can detect whether depreciation expenses have been claimed consistently across tax years and suggest appropriate deductions if they have been overlooked. Similarly, if a taxpayer has made charitable donations, the system 200 can identify this situation and recommend claiming a charitable deduction. This capability is facilitated by the tax situation identifier 211A, which cross-references the identified changes with the tax rules stored in the knowledge store 212A to detect specific tax situations.

As noted above, the knowledge store 212A in the system 200 uses a vector store to store tax rules. This vector store allows for faster retrieval and more precise identification of each comparison mismatch between different tax years, providing a unique tax situation to the user. The knowledge store 212A ensures that comparisons and suggestions made by the system 200 are based on the current tax regulations, enhancing the accuracy and reliability of the system's recommendations.

As noted above, the system 200 also includes a data ingestion module 214, which retrieves and processes tax-related information from external sources. The data ingestion module 214 includes an IRS publications data service 214A and S3 storage 214B. The IRS publications data service 214A provides access to various tax publications, such as tax forms, instructions, and guides, which can be used to interpret and analyze the tax return data. The S3 storage 214B stores tax-related data, such as historical tax return data, tax rules, and regulations, which can be used by the system 200 for comparison and analysis.

The knowledge store 212A is a database that stores tax rules. The tax rules may include information about income tax rates, tax brackets, deductions, credits, and other relevant tax laws and regulations. The knowledge store 212A may use a vector store or other data structure to enable rapid retrieval and application of tax rules. The knowledge store 212A may be updated regularly to ensure that the system 200 is working with the current tax laws and regulations. The tax situation identifier 211A and the deductions identifier 211B use the tax rules stored in the knowledge store 212A to validate the identified changes and deductions.

The AnswerPlugin REST 212B is a software component that provides a RESTful interface for retrieving and processing tax-related information. The AnswerPlugin REST 212B may interact with external data sources, such as IRS databases or other tax-related data services, to retrieve up-to-date tax information. The AnswerPlugin REST 212B may also interact with the genAI module and the partial tax return interpretation engine 206 to process and analyze the retrieved tax information.

The GenOS plugin for tax data retrieval 212C is a software component that is configured to retrieve tax data from various sources. The GenOS plugin for tax data retrieval 212C may interact with the IRS interface 216, the IRS publications data service 214A, and the S3 storage 214B to retrieve tax-related data. The retrieved data may include tax return data, tax rules, regulations, and other relevant tax information. The GenOS plugin for tax data retrieval 212C may provide the retrieved data to other components of the system 200 for further processing and analysis.

In operation, the GenOS runtime module (?) 212 processes tax data and integrates with other modules of the system 200 to enhance the automated tax analysis capabilities. The GenOS runtime 212 retrieves tax-related information from external sources using the AnswerPlugin REST 212B and the GenOS plugin for tax data retrieval 212C. The retrieved information is processed and analyzed by the partial tax return interpretation engine 206 and the genAI module. The tax situation identifier 211A and the deductions identifier 211B use the tax rules stored in the knowledge store 212A to validate the identified changes and deductions. The gen UX module 210 generates a human-readable report that includes the detected tax situations and the potential deductions. The user or the accountant can then review the report and implement the suggested changes.

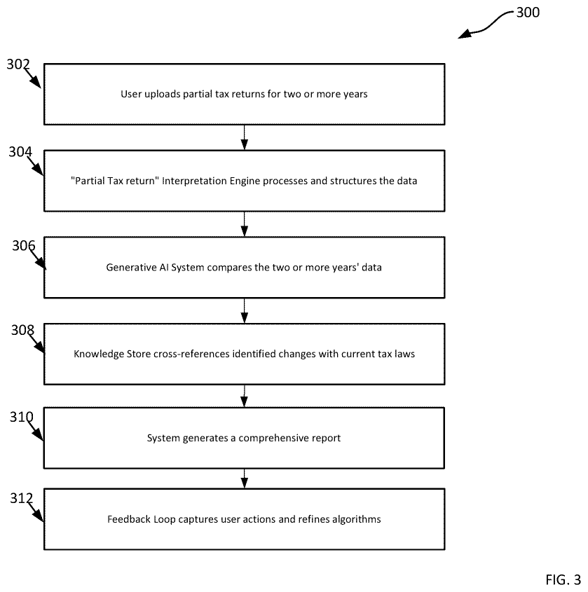

Referring to FIG. 3, a process 300 for automated tax return analysis using genAI according to the disclosed principles is now described. The process 300 begins with step 302, where a user uploads partial tax returns for two or more years to the system 100 via the user device 102. The uploaded tax returns may be in the form of digital documents, such as PDF files or electronic forms, and may contain information about the taxpayer's income, expenses, deductions, credits, and other relevant tax information. The tax returns may be complete or partial and may be structured or unstructured.

In step 304, the “Partial Tax return” Interpretation Engine 106 processes and structures the data from the uploaded returns. The Interpretation Engine 106 uses advanced NLP algorithms, such as BERT or GPT to interpret the tax return data. These algorithms are capable of understanding the context and semantics of the tax return data, even when the data is incomplete or unstructured. The Interpretation Engine 106 extracts relevant tax information from the tax return data and structures the extracted data for further processing.

In step 306, the genAI system 104 compares the structured tax return data from the two or more tax years. The genAI system 104 uses generative models, such as GANs or VAEs, to generate a human-readable comparison of the tax returns. The genAI system 104 identifies changes in income, expenses, and potential deductions, and generates a comparison result that highlights these changes.

In step 308, the knowledge store 108 cross-references the identified changes with current tax laws and regulations. The knowledge store 108 uses a vector store to store tax rules, enabling rapid retrieval and precise identification of each comparison mismatch between different tax years. The knowledge store 108 validates the identified changes and potential deductions against the stored tax rules, ensuring that the system's recommendations are in line with current tax laws and regulations.

The process 300 continues to step 310, where the system 100 generates a comprehensive, human-readable report based on the analysis. The report includes a comparison of the tax returns, highlighting the changes in income, expenses, and potential deductions. The report also includes suggestions for optimizing the taxpayer's tax situation, such as claiming missed deductions or adjusting income or expenses. The report is personalized to the taxpayer's specific situation, providing tailored insights and recommendations based on the taxpayer's income, expenses, life events, and other relevant factors.

In step 312, a feedback Loop captures user actions and refines the algorithms used in the process 300. The feedback Loop incorporates reinforcement learning techniques to learn from user feedback and continuously improve the system's performance and accuracy. The feedback Loop analyzes user interactions with the system 100, such as the user's responses to the system's recommendations, and adapts the system's algorithms based on these interactions. This allows the system 100 to learn and improve over time, optimizing its performance and accuracy in automated tax return analysis.

In some cases, the process 300 may include additional steps or variations. For example, the process 300 may include a step of validating the user's identity before the user can upload tax returns to the system 100. The process 300 may also include a step of encrypting the tax return data to ensure the privacy and security of the user's information. In some aspects, the process 300 may include a step of notifying the user when the report is ready for review. These additional steps and variations may be implemented as needed to meet the specific requirements of different use cases or scenarios.

Referring back to the example use case mentioned above, the automated tax situation and deduction detection system may be employed by a small business owner who runs a home-based graphic design company. The small business owner has been managing her own taxes for the past few years but has found the process increasingly complex as her business has grown. She decides to use the automated system to analyze her tax returns from the previous two years and gain insights for the current tax year.

In step 302, the small business owner uploads her partial tax returns from the past two years into the system. She uses the accountant interface 202 to input her tax data, which may include information from her PTO software 202A and Lacerte software 202B. The system processes these as tax return 1 203A and tax return 2 203B through the tax engine 204.

During step 304, the partial tax return interpretation engine 206 uses NLP to interpret and structure the data from the returns, even though some information may be missing or incomplete. This engine may employ advanced algorithms to understand the context of the small business owner's business expenses, income sources, and potential deductions related to her home-based business.

In step 306, the comparer 208, which is part of the genAI module, compares the processed tax return data and identifies changes between the two years. For the small business owner, this may include an increase in business income, new equipment purchases for her graphic design work, and changes in home office expenses.

Step 308 involves the GenOS runtime 212 and its components. The knowledge store 212A, which contains up-to-date tax rules, is used to cross-reference the identified changes. The tax situation identifier 211A detects several relevant tax situations for the small business owner, such as the potential for a home office deduction and depreciation of newly purchased equipment. The AnswerPlugin REST 212B and GenOS plugin for tax data retrieval 212C may be used to gather additional relevant tax information specific to her situation.

In step 310, the gen UX module 210 generates a comprehensive, human-readable report for the small business owner. This report outlines the detected tax situations and recommended deductions. It highlights the increase in her business income, suggests claiming a home office deduction, and provides guidance on how to depreciate her new equipment purchases. The report may also identify a missed opportunity from the previous year where the small business owner could have claimed a deduction for professional development courses she attended.

In step 312, as the small business owner reviews the report and implements the suggested changes, the system captures her actions. If the small business owner accepts the recommendation to claim a home office deduction but declines to claim depreciation on certain equipment, the system learns from these choices. This feedback is used to refine the system's algorithms, potentially improving future recommendations for similar small business owners in the graphic design industry.

Throughout this process, the data ingestion module 214 may continuously update the system with the latest tax regulations from the IRS publications data service 214A and historical tax data from S3 storage 214B. The IRS interface 216 ensures that recommendations are in line with the current IRS guidelines, providing the small business owner with accurate and up-to-date tax advice for her small business.

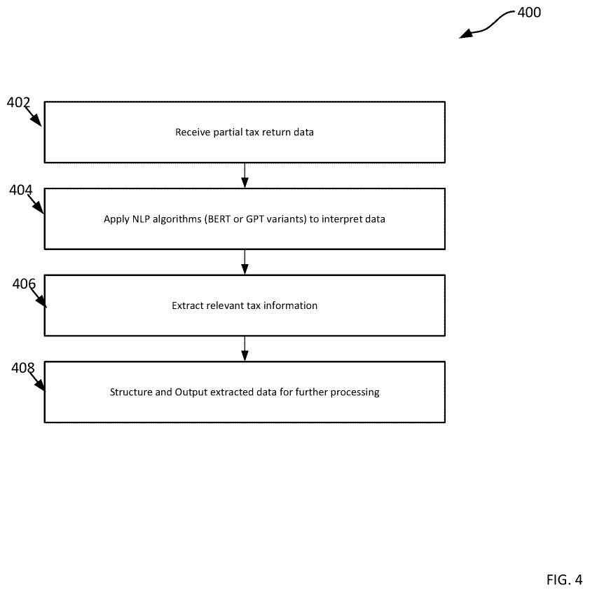

Referring to FIG. 4, a process 400 for interpreting partial tax return data according to the disclosed principles is now described. The process 400 begins with step 402, where the system 200 receives partial tax return data. The partial tax return data may be in the form of digital documents, such as PDF files or electronic forms, and may contain information about the taxpayer's income, expenses, deductions, credits, and other relevant tax information. The tax return data may be incomplete or unstructured and may be input into the system 200 through the accountant interface 202 or may be automatically retrieved from a database or other data source.

In step 404, the partial tax return interpretation engine 206 applies NLP algorithms to interpret the received data. The NLP algorithms may include transformer-based models like BERT or GPT. These advanced NLP algorithms are capable of understanding the context and semantics of the tax return data, even when the data is incomplete or unstructured. The NLP algorithms can analyze the content of the tax return, extract relevant tax information, and generate a structured format that can be easily compared with the previous year's tax return.

In some aspects, the NLP algorithms employed by the partial tax return interpretation engine 206 may utilize a combination of techniques to enhance their performance and accuracy. These techniques may include named entity recognition (NER) to identify and classify specific tax-related entities such as income sources, deduction categories, and tax credits. Additionally, the system may employ sentiment analysis to gauge the overall financial health of the taxpayer based on the language used in any accompanying notes or explanations. The NLP algorithms may also incorporate domain-specific pre-training on large datasets of tax-related documents, enabling them to better understand tax-specific terminology and concepts. This multi-faceted approach allows the system to not only extract explicit information from the tax return data but also infer implicit details that may be beneficial for accurate tax analysis and optimization.

In step 406, the partial tax return interpretation engine 206 extracts relevant tax information from the interpreted data. The extracted tax information may include details about the taxpayer's income, expenses, deductions, credits, and other relevant tax information. The extraction process may involve parsing the structured tax return data, identifying relevant tax information, and extracting this information for further processing.

In some aspects, the extraction process may employ advanced machine learning techniques to enhance the accuracy and efficiency of tax information extraction. The partial tax return interpretation engine 206 may utilize deep learning models, such as convolutional neural networks (CNNs) or recurrent neural networks (RNNs), to identify patterns and relationships within the tax return data. These models may be trained on large datasets of historical tax returns to recognize complex tax scenarios and extract relevant information even from ambiguous or incomplete data. Additionally, the system may implement a hierarchical attention mechanism to focus on the beneficial elements of the tax return, prioritizing critical information such as income sources, major deductions, and potential red flags for audits. This sophisticated extraction process may also incorporate rule-based systems to ensure compliance with specific tax regulations, combining the flexibility of machine learning with the precision of predefined tax rules.

In step 408, the partial tax return interpretation engine 206 structures the extracted tax information for further processing. The structuring process may involve organizing the extracted tax information into a structured format, such as a database or a data frame, that can be easily processed by other components of the system 200. The structured tax information may be output for further processing by the genAI module 104 and the comparer 208.

In some aspects, the structuring process may employ advanced data modeling techniques to optimize the organization and representation of the extracted tax information. The partial tax return interpretation engine 206 may utilize graph databases to capture complex relationships between various tax entities, such as income sources, deductions, and credits. This graph-based representation allows for efficient querying and analysis of interconnected tax data. Additionally, the system may implement a hierarchical data structure to represent nested tax information, such as itemized deductions or multi-level business expenses. To enhance data integrity and consistency, the structuring process may also incorporate data validation rules and constraints based on predefined tax schemas. These schemas may be dynamically updated to reflect changes in tax laws and regulations. Furthermore, the structured tax data may be indexed and optimized for fast retrieval, enabling real-time analysis and comparison by the genAI module 104 and the comparer 208. This advanced structuring approach not only facilitates efficient processing but also enables more sophisticated tax analysis and optimization strategies.

Continuing with the specific use case of the small business owner, the small business owner running a home-based graphic design company, we can illustrate how each step in FIG. 4 applies to her situation, referencing the technical details in FIG. 2.

In step 402, the small business owner, uploads her partial tax returns for the past two years through the accountant interface 202. The system 200 receives this data, which may include information from her PTO software 202A and Lacerte software 202B. For example, the small business owner's partial returns might contain her business income from graphic design projects, expenses related to her home office, and purchases of new design software and hardware. However, some information may be missing or incomplete, such as detailed breakdowns of client payments or certain business-related travel expenses.

In step 404, the partial tax return interpretation engine 206 applies NLP algorithms to interpret the small business owner's tax data. Using advanced models like BERT or GPT, the engine processes the unstructured information from her returns. For instance, it may analyze free-text descriptions of expenses in the small business owner's returns, understanding context to correctly categorize a “new personal computer” as a depreciable business asset rather than a personal expense. The engine may also employ named entity recognition to identify and classify specific tax-related entities in the small business owner's returns, such as recognizing “Adobe Creative Suite subscription” as a deductible business expense.

During step 406, the partial tax return interpretation engine 206 extracts relevant tax information from small business owner's interpreted data. Using deep learning models like CNNs or RNNs, the engine identifies patterns and relationships within her tax returns. For example, it might recognize a pattern of increasing business income over the two years, extract specific amounts for new equipment purchases, and identify potential deductions related to her home office expenses. The system may use a hierarchical attention mechanism to prioritize critical information, such as focusing on small business owner's significant increase in business income or the purchase of expensive design software.

In step 408, the partial tax return interpretation engine 206 structures the extracted tax information from small business owner's returns. It may organize this data into a graph database, representing complex relationships between the small business owner's income sources (various clients), expenses (software subscriptions, hardware purchases), and potential deductions (home office, professional development courses). The system might create a hierarchical data structure to represent the small business owner's itemized deductions, including nested categories for business expenses. This structured data is optimized for fast retrieval and comparison, allowing the genAI module 104 and comparer 208 to efficiently analyze the small business owner's tax situation and generate personalized recommendations for optimizing her tax return.

In some cases, the process 400 may include additional steps or variations. For example, the process 400 may include a step of validating the tax return data before it is processed by the partial tax return interpretation engine 206. The process 400 may also include a step of encrypting the tax return data to ensure the privacy and security of the user's information. In some aspects, the process 400 may include a step of normalizing the tax return data to ensure consistency and comparability across different tax years. These additional steps and variations may be implemented as needed to meet the specific requirements of different use cases or scenarios.

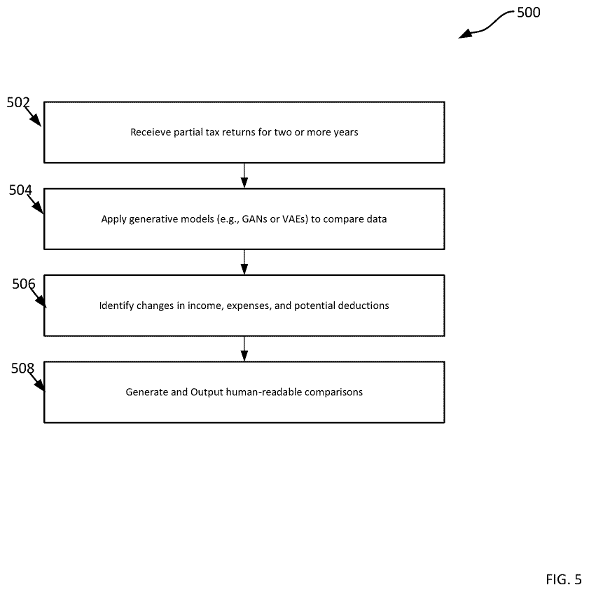

Referring to FIG. 5, a process 500 for analyzing tax returns using genAI is now described. The process 500 begins with step 502, where the system 200 receives structured tax data from two or more tax years. The structured tax data may be the output of the partial tax return interpretation engine 206, which has processed and structured the tax return data using advanced NLP algorithms. The structured tax data may include information about the taxpayer's income, expenses, deductions, credits, and other relevant tax information.

In step 504, the genAI module 104 applies generative models to compare the structured tax data from the two or more tax years. The generative models may GANs or VAEs. These generative models are capable of learning from existing tax return data and generating a comparison that captures the differences between the tax returns. The generative models may be trained on a vast array of historical tax return data, enabling them to recognize patterns and infer potential deductions that may apply to the taxpayer's circumstances.

In some aspects, the genAI module 104 may employ advanced techniques to enhance the comparison process and generate more accurate and insightful results. The module may utilize attention mechanisms to focus on specific areas of the tax returns that are likely to yield significant differences or potential deductions. Additionally, the system may implement transfer learning techniques, allowing the generative models to leverage knowledge gained from analyzing a wide range of tax scenarios and apply it to individual cases. The genAI module 104 may also incorporate ensemble methods, combining the outputs of multiple generative models to produce more robust and reliable comparisons. This approach may help to mitigate biases and improve the overall accuracy of the tax return analysis. Furthermore, the system may employ reinforcement learning algorithms to continuously refine its comparison strategies based on feedback from tax professionals and successful outcomes, ensuring that the generative models adapt to evolving tax regulations and optimization techniques.

Following this, in step 506, the genAI module 104 identifies changes in income, expenses, and potential deductions based on the comparison. The identified changes may include increases or decreases in income or expenses, new or missed deductions, changes in tax credits, and other relevant changes. The identified changes provide a detailed overview of the differences between the tax returns from the two or more tax years, highlighting areas that may affect the taxpayer's tax situation.

In some aspects, the genAI module 104 may employ sophisticated pattern recognition algorithms to identify subtle changes and trends in the tax data. These algorithms may utilize machine learning techniques such as decision trees, random forests, or gradient boosting to detect complex relationships between various tax elements. The module may also implement anomaly detection methods to identify unusual changes or discrepancies that may require further investigation. Additionally, the system may use predictive analytics to forecast potential future changes based on historical trends and current economic indicators. This predictive capability may help taxpayers anticipate future tax liabilities and make informed financial decisions. The genAI module 104 may also incorporate natural language generation techniques to provide detailed explanations of the identified changes, making the analysis more accessible and understandable to users without extensive tax knowledge.

In step 508, the genAI module 104 generates and outputs human-readable comparisons of the analyzed tax returns. The human-readable comparisons may be in the form of a report or a summary that highlights the identified changes and potential deductions. The report may include a side-by-side comparison of the tax returns, a list of identified changes, and suggestions for potential deductions. The report may be easily understandable by non-expert users, providing them with a clear and concise overview of their tax situation.

In some aspects, the genAI module 104 may employ advanced NLG techniques to produce the human-readable comparisons. These NLG models may utilize transformer-based architectures, such as GPT or T5, to generate coherent and contextually relevant explanations of the tax return analysis. The system may implement a template-based approach combined with dynamic content generation to ensure consistency in report structure while allowing for personalized insights. Additionally, the module may incorporate data visualization techniques, such as interactive charts and graphs, to present complex tax information in an easily digestible format. The system may also employ adaptive language models that can adjust the complexity of the generated text based on the user's level of tax knowledge, ensuring that the report is accessible to both novice taxpayers and experienced professionals. Furthermore, the genAI module 104 may utilize multi-modal generation techniques to create reports that combine textual explanations with visual aids, enhancing the overall comprehension of the tax analysis results.

Continuing with the specific use case of the small business owner, the small business owner running a home-based graphic design company, we can illustrate how each step in FIG. 5 applies to her situation, referencing the technical details in FIG. 2.

In step 502, the system 200 receives structured tax data from the small business owner's two recent tax years. This data has been processed and structured by the partial tax return interpretation engine 206, which has used advanced NLP algorithms to interpret the small business owner's uploaded partial tax returns. The structured data may include information about the small business owner's business income from various graphic design projects, her home office expenses, equipment purchases, and other relevant tax information. For example, it may contain structured data about her income from different clients, expenses related to software subscriptions like Adobe Creative Suite, and details about her new personal computer purchase.

In step 504, the genAI module 104, which includes the comparer 208, applies generative models such as GANs or VAEs to compare the small business owner's structured tax data from the two years. These models may have been trained on a vast array of historical tax return data from small business owners in creative industries. The comparer 208 may use attention mechanisms to focus on specific areas of the small business owner's tax returns that are likely to yield significant differences or potential deductions, such as her business income, home office expenses, and equipment depreciation. For instance, it may pay particular attention to the increase in the small business owner's business income and the addition of new equipment purchases in the more recent tax year.

In step 506, the genAI module 104 identifies changes in the small business owner's income, expenses, and potential deductions based on the comparison. It may detect an increase in her business income from graphic design projects, new deductions related to her personal computer purchase, changes in her home office expenses, or variations in her software subscription costs. The module may employ sophisticated pattern recognition algorithms to identify subtle trends, such as a gradual increase in expenses related to professional development courses. It may also use anomaly detection methods to flag unusual changes, like a sudden spike in travel expenses related to attending a design conference.

In step 508, the gen UX module 210 generates and outputs a human-readable comparison of the small business owner's analyzed tax returns. This report may be structured to highlight the changes identified in step 506. For example, it might include a side-by-side comparison of the small business owner's business income for both years, showing the percentage increase. It may list new deductions the small business owner could claim, such as depreciation on her new personal computer. The report might also suggest potential tax-saving strategies, like increasing contributions to a self-employed retirement plan given her higher income. The gen UX module 210 may use advanced NLG techniques to generate explanations tailored to the small business owner's level of tax knowledge, ensuring the report is both informative and easily understandable.

Throughout this process, the knowledge store 212A within the GenOS runtime 212 may be continually accessed to ensure that the analysis and recommendations comply with the latest tax rules and regulations. The AnswerPlugin REST 212B and GenOS plugin for tax data retrieval 212C may be used to fetch any additional information needed for the analysis, such as updated depreciation schedules for computer equipment used in a home office.

This use case demonstrates how the system 200 can provide a comprehensive, personalized tax analysis for a small business owner like the small business owner, leveraging advanced AI techniques to identify opportunities for tax optimization and provide clear, actionable insights.

In some cases, the process 500 may include additional steps or variations. For example, the process 500 may include a step of validating the identified changes and potential deductions against current tax laws and regulations. This validation step may involve cross-referencing the identified changes with the tax rules stored in the knowledge store 108, ensuring that the system's recommendations are in line with current tax laws and regulations. The process 500 may also include a step of generating personalized insights and recommendations based on the taxpayer's specific situation. These personalized insights may include tailored suggestions for maximizing tax efficiency and compliance, providing the taxpayer with actionable recommendations for their tax planning and preparation.

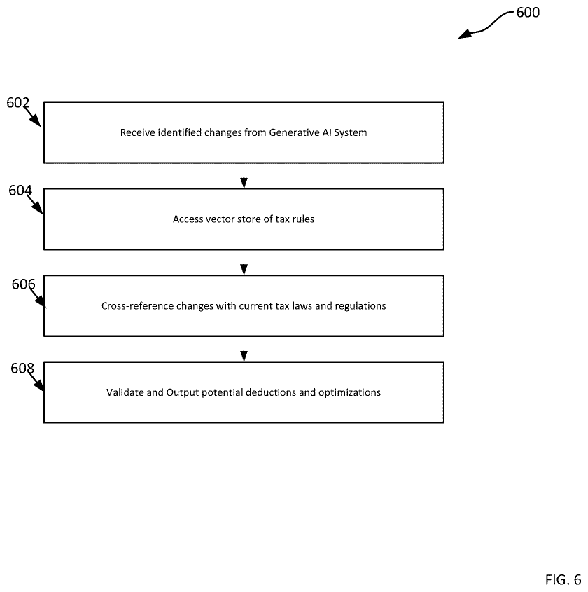

Referring to FIG. 6, a process 600 for validating and optimizing tax deductions is now described. The process 600 begins with step 602, where the system 200 receives identified changes from the genAI system 104. The identified changes may include differences in income, expenses, and potential deductions between the tax returns from two or more tax years. These changes are identified based on the comparison of the structured tax data from the two or more tax years.

In step 604, the system 200 accesses the knowledge store 108, which contains a vector store of tax rules. The vector store allows for faster retrieval and more precise identification of each comparison mismatch between different tax years. The vector store may include information about income tax rates, tax brackets, deductions, credits, and other relevant tax laws and regulations. The vector store may be updated regularly to ensure that the system 200 is working with the current tax laws and regulations.

In some aspects, the vector store in the knowledge store 108 may utilize advanced indexing techniques to optimize the storage and retrieval of tax rules. The system may implement a multi-dimensional indexing structure, such as a k-d tree or R-tree, to efficiently organize and search through the high-dimensional space of tax rules. This approach may enable rapid nearest-neighbor searches, allowing the system to quickly identify the relevant tax rules for a given tax situation. Additionally, the vector store may employ techniques like locality-sensitive hashing (LSH) to further accelerate similarity searches across tax rules. The system may also implement a caching mechanism that stores frequently accessed tax rules in high-speed memory, reducing latency for common queries. To handle the dynamic nature of tax regulations, the vector store may utilize a versioning system that maintains historical snapshots of tax rules, enabling the system to apply the correct set of rules based on the tax year being analyzed. This sophisticated vector store architecture may enhance the system's ability to process complex tax scenarios efficiently and accurately.

In step 606, the system 200 cross-references the identified changes with the current tax laws and regulations stored in the knowledge store 108. The system 200 uses a tax situation identifier to detect tax situations based on the cross-referenced changes. The tax situation identifier may be a software component or algorithm that is configured to match the identified changes with the tax rules stored in the vector store. The tax situation identifier may use various matching techniques, such as pattern matching, rule-based matching, or machine learning-based matching, to detect tax situations.

In some aspects, the tax situation identifier may employ advanced machine learning techniques to enhance its ability to detect complex tax situations. The system may utilize deep learning models, such as CNNs or RNNs to analyze the multidimensional relationships between various tax elements and identify intricate patterns that may indicate specific tax situations. These models may be trained on large datasets of historical tax returns and known tax situations, allowing them to recognize subtle indicators that might be missed by traditional rule-based systems. Additionally, the tax situation identifier may incorporate NLP capabilities to interpret and analyze textual information within tax returns, such as descriptions of business expenses or explanations of unusual financial transactions. This NLP functionality may enable the system to extract valuable context from unstructured data, further improving its ability to accurately identify and classify tax situations. The tax situation identifier may also implement a hierarchical classification system, first identifying broad categories of tax situations before drilling down into more specific subcategories, allowing for a more nuanced and accurate analysis of the taxpayer's circumstances.

In step 608, the system 200 validates potential deductions and optimizations based on the detected tax situations. The system 200 uses a deductions identifier to determine potential tax deductions. The deductions identifier may be a software component or algorithm that is configured to identify potential tax deductions based on the detected tax situations. The deductions identifier may use various deduction identification techniques, such as rule-based deduction identification, machine learning-based deduction identification, or statistical deduction identification, to determine potential tax deductions.

In some aspects, the deductions identifier may employ a multi-stage approach to enhance its accuracy and efficiency in identifying potential tax deductions. The system may first utilize a rule-based engine to apply straightforward tax rules and regulations, quickly identifying common deductions that clearly apply to the detected tax situations. Following this initial pass, the deductions identifier may leverage machine learning models, such as gradient boosting machines or deep neural networks, to analyze more complex scenarios and identify less obvious deduction opportunities. These models may be trained on extensive datasets of historical tax returns, allowing them to recognize intricate patterns and relationships between various tax elements that may indicate potential deductions. The system may also incorporate a probabilistic reasoning component, using Bayesian networks or Markov random fields, to handle uncertainty in tax situations and provide confidence scores for each identified deduction. This multi-stage approach may allow the deductions identifier to balance speed and accuracy, providing rapid results for straightforward cases while still offering sophisticated analysis for more complex tax scenarios.

The process 600 outputs validated information for report generation. The validated information may include a list of detected tax situations, a list of potential tax deductions, and a list of suggested optimizations. The validated information may be used to generate a comprehensive, human-readable report that includes the detected tax situations, the potential tax deductions, and the suggested optimizations.

Continuing with the small business owner's use case for each step in FIG. 6, referencing the technical details in FIG. 2:

In step 602, the system 200 receives identified changes from the genAI system 104, which includes the comparer 208. For the small business owner's case, these changes may include the increase in her business income from graphic design projects, the purchase of her new personal computer, changes in her home office expenses, and variations in her software subscription costs. The comparer 208 may have identified these changes by comparing the small business owner's structured tax data from the two years using advanced generative models like GANs or VAEs.

In step 604, the system accesses the knowledge store 212A within the GenOS runtime 212. This knowledge store contains a vector store of tax rules relevant to the small business owner's situation as a small business owner in the graphic design industry. The vector store may include information about home office deductions, equipment depreciation rules, and self-employed retirement plan contributions. The system may use advanced indexing techniques, such as k-d trees or R-trees, to quickly retrieve the relevant tax rules for the small business owner's specific situation.

For step 606, the tax situation identifier 211A cross-references the identified changes in the small business owner's tax returns with the current tax laws and regulations stored in the knowledge store 212A. For example, it may detect that the small business owner's new personal computer purchase qualifies for equipment depreciation, or that her increased business income might make her eligible for additional retirement plan contributions. The tax situation identifier may use deep learning models like CNNs or RNNs to analyze the multidimensional relationships between various elements of the small business owner's tax return, potentially identifying complex tax situations that might be missed by traditional rule-based systems.

In step 608, the deductions identifier 211B validates potential deductions and optimizations based on the detected tax situations. For the small business owner, this may involve determining the appropriate depreciation schedule for her new personal computer, calculating the exact amount she can claim for her home office deduction, or identifying the allowable contribution to a self-employed retirement plan based on her increased income. The deductions identifier may employ a multi-stage approach, first using a rule-based engine to identify common deductions, then leveraging machine learning models to analyze more complex scenarios and identify less obvious deduction opportunities specific to The small business owner's situation as a graphic designer.

The process 600 then outputs validated information for report generation. For the small business owner, this may include a detailed list of detected tax situations (e.g., equipment purchase, home office use, increased business income), potential tax deductions (e.g., equipment depreciation, home office deduction, increased retirement plan contributions), and suggested optimizations (e.g., timing of expenses, structuring of business income). This validated information is then used by the gen UX module 210 to generate a comprehensive, human-readable report tailored to the small business owner's level of tax knowledge, providing her with clear, actionable insights for optimizing her tax situation as a small business owner in the graphic design industry.

In some cases, the process 600 may include additional steps or variations. For example, the process 600 may include a step of validating the identified changes before they are cross-referenced with the tax rules. This validation step may involve checking the identified changes for errors or inconsistencies and correcting or discarding any erroneous or inconsistent changes. The process 600 may also include a step of updating the vector store with new tax rules or regulations. This update step may involve retrieving new tax rules or regulations from an external source, such as an IRS database, and adding the new rules or regulations to the vector store. These additional steps and variations may be implemented as needed to meet the specific requirements of different use cases or scenarios.

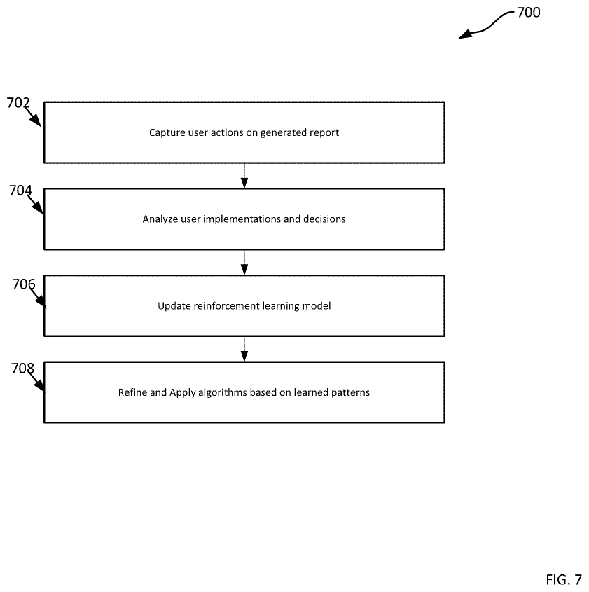

Referring to FIG. 7, a process 700 for refining the system's performance using a feedback loop is now described. The process 700 begins with step 702, where the system 200 captures user actions on the generated report. The user actions may include the user's responses to the system's recommendations, such as whether the user accepts or rejects the suggested deductions, and any changes the user makes to their tax return based on the system's recommendations. The user actions provide valuable feedback that the system 200 can use to learn and improve its performance.

Following this, in step 704, the system 200 analyzes the user's implementations and decisions based on the captured actions. The system 200 may use various analysis techniques, such as statistical analysis, machine learning, or data mining, to understand the user's behavior and preferences. The analysis may reveal patterns or trends in the user's actions, such as a tendency to accept certain types of deductions or a preference for certain tax planning strategies. These insights can help the system 200 to better tailor its recommendations to the user's specific needs and preferences.

In some aspects, the system 200 may employ advanced machine learning techniques to enhance its analysis capabilities. For instance, the system may utilize ensemble methods, combining multiple machine learning models such as random forests, gradient boosting machines, and neural networks, to improve the accuracy and robustness of its user behavior predictions. The system may also implement NLP algorithms to analyze any textual feedback or comments provided by users, extracting sentiment and intent to gain deeper insights into user preferences. Additionally, the system may employ time series analysis techniques to identify temporal patterns in user behavior, such as changes in preferences over time or in response to specific events like tax law changes. To handle the high-dimensional nature of tax data, the system may utilize dimensionality reduction techniques like principal component analysis (PCA) or t-SNE to identify the relevant features influencing user decisions. These advanced analytical techniques may enable the system 200 to create more nuanced and accurate user profiles, leading to increasingly personalized and effective tax recommendations over time.

In step 706, the system 200 updates its reinforcement learning model based on the analyzed user actions. The reinforcement learning model is a type of machine learning model that learns from feedback and adjusts its behavior to increase (e.g., maximize) a reward signal. In this case, the reward signal may be a measure of the system's accuracy or effectiveness in identifying tax situations and potential deductions. The system 200 adjusts the parameters of the reinforcement learning model based on the feedback received from the user actions, with the goal of improving the system's performance on future tax return analyses.

In some aspects, the reinforcement learning model employed by the system 200 may utilize advanced techniques to optimize its learning process and improve its performance over time. The system may implement a deep Q-network (DQN) architecture, which combines reinforcement learning with deep neural networks to handle high-dimensional state spaces typical in complex tax scenarios. This approach may allow the system to learn optimal strategies for identifying tax situations and deductions across a wide range of user profiles and tax circumstances. Additionally, the system may incorporate policy gradient methods, such as Proximal Policy Optimization (PPO) or Trust Region Policy Optimization (TRPO), to directly optimize the policy for recommending tax strategies. These methods may enable more stable and efficient learning, particularly in scenarios with continuous action spaces. To address the challenge of sparse rewards in tax optimization, the system may employ intrinsic motivation techniques, such as curiosity-driven exploration, encouraging the model to explore potentially beneficial tax strategies that may not have immediate rewards. Furthermore, the system may utilize meta-learning algorithms to adapt quickly to new tax scenarios or changes in tax laws, allowing it to generalize its knowledge across different tax years and jurisdictions more effectively.

In step 708, the system 200 refines its algorithms based on the learned patterns from the reinforcement learning model. The system 200 may adjust its NLP algorithms, generative models, tax situation identification methods, deduction identification methods, or other aspects of its operation to better align with the learned patterns. This refinement process allows the system 200 to continuously improve its performance and accuracy in automated tax return analysis, making it more effective and useful over time.

In some aspects, the system 200 may implement advanced optimization techniques to enhance the refinement process in step 708. The system may utilize genetic algorithms or evolutionary strategies to evolve and optimize its algorithms over time. These techniques may involve creating multiple variations of the system's algorithms, evaluating their performance on historical and simulated tax scenarios, and selecting the best-performing variants for further refinement. The system may also employ transfer learning techniques to leverage knowledge gained from one tax domain or jurisdiction to improve performance in others, potentially accelerating the learning process for new tax scenarios. Additionally, the system may implement a multi-agent reinforcement learning approach, where different components of the system (e.g., NLP algorithms, generative models, tax situation identifiers) are treated as separate agents that learn to cooperate and optimize their collective performance. This approach may enable more nuanced and targeted improvements across different aspects of the system's functionality. Furthermore, the system may utilize explainable AI techniques to generate human-readable justifications for its algorithmic adjustments, allowing tax professionals to validate and provide feedback on the system's learning process, thereby ensuring that the refinements align with expert knowledge and regulatory requirements.

Continuing with the small business owner's use case for each step in FIG. 7, referencing the technical details in FIG. 2:

In step 702, the system 200 captures the small business owner's actions on the generated report. After reviewing the comprehensive report produced by the gen UX module 210, the small business owner may accept some recommendations while rejecting others. For instance, she might accept the suggestion to claim a home office deduction and depreciate her new personal computer, but decide against increasing her retirement plan contributions. The system captures these decisions through the accountant interface 202, which may include interactive elements allowing the small business owner to indicate her choices directly within the report.

In step 704, the system 200 analyzes the small business owner's implementations and decisions. The gen UX module 210 may employ machine learning algorithms to process the small business owner's choices, identifying patterns in her decision-making. For example, it might recognize that the small business owner tends to accept equipment-related deductions but is more conservative with retirement planning suggestions. The system may also use natural language processing to analyze any comments The small business owner leaves, gauging her sentiment towards different types of tax strategies.

For step 706, the system 200 updates its reinforcement learning model based on the small business owner's actions. The GenOS runtime 212 may incorporate the small business owner's decisions into its learning algorithms. For instance, if the small business owner consistently accepts home office deductions but rejects certain business expense claims, the system might adjust its reward function to prioritize accuracy in home office calculations while being more conservative in suggesting certain types of business expenses for similar small business owners in the creative industry.

In step 708, the system 200 refines its algorithms based on the learned patterns. The partial tax return interpretation engine 206 might adjust its natural language processing algorithms to better identify potential home office deductions in future tax returns. The comparer 208 could refine its generative models to produce more accurate comparisons of equipment depreciation schedules. The tax situation identifier 211A and deductions identifier 211B may evolve to more precisely detect tax situations and calculate deductions relevant to small business owners in the graphic design industry, based on the patterns learned from the small business owner's interactions.

In some cases, the process 700 may include additional steps or variations. For example, the process 700 may include a step of validating the user's actions before they are captured and analyzed. This validation step may involve checking the user's actions for errors or inconsistencies and correcting or discarding any erroneous or inconsistent actions. The process 700 may also include a step of updating the reinforcement learning model with new tax rules or regulations. This update step may involve retrieving new tax rules or regulations from an external source, such as an IRS database, and adding the new rules or regulations to the reinforcement learning model. These additional steps and variations may be implemented as needed to meet the specific requirements of different use cases or scenarios.

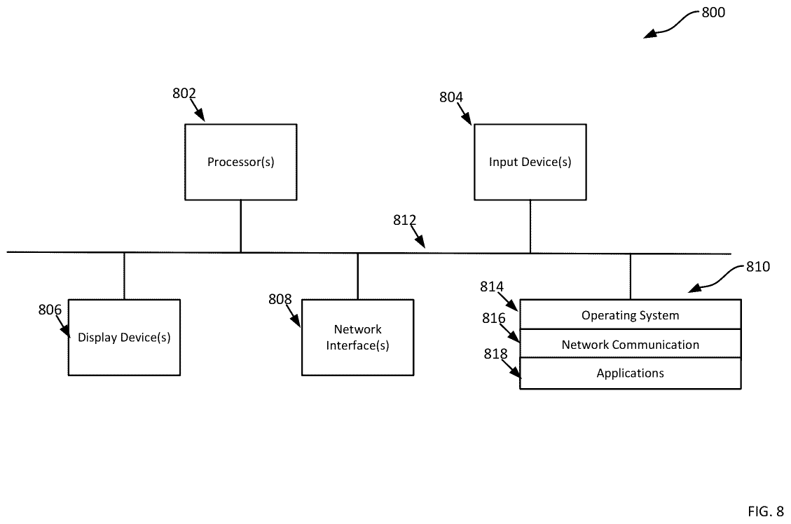

Referring to FIG. 8, a system diagram 800 of a computing system is now described. The computing system may be used to implement the automated tax return analysis system 100 or 200 as described above. The computing system includes several interconnected components, including processors 802, input devices 804, display devices 806, and network interfaces 808. These components are connected via a data flow path 810, which facilitates communication and data exchange between the components.

The processors 802 may include one or more central processing units (CPUs), graphics processing units (GPUs), or other types of processing units. The processors 802 are responsible for executing the instructions and operations of the system's software components, such as the operating system 814, network communication 816, and applications 818. The processors 802 may also execute the algorithms of the genAI module 104, the interpretation engine 106, and other components of the system 100 or 200.

The input devices 804 may include keyboards, mice, touchscreens, or other types of input devices. The input devices 804 allow a user to interact with the system and input data, such as tax return data, into the system. The display devices 806 may include monitors, screens, or other types of display devices. The display devices 806 provide a visual interface for the user to view the system's output, such as the generated tax return analysis report.

The network interfaces 808 enable the system to connect to a network, such as a local area network (LAN), a wide area network (WAN), or the internet. The network interfaces 808 facilitate communication between the system and other devices or systems connected to the network. The network interfaces 808 may also enable the system to access external data sources, such as IRS databases or other tax-related data services.

The data flow path 810 represents the data connection 812 that facilitates the exchange of data between the various components of the system. The data connection 812 may include various types of data connections, such as wired or wireless connections, and may support various data communication protocols.

The system diagram 800 also includes a multi-layered software structure, which includes an operating system 814, network communication 816, and applications 818. The operating system 814 manages the system's hardware resources and provides services for the system's software applications. The network communication 816 handles the system's network connections and data communications. The applications 818 include various software applications that provide the system's functionality, such as the genAI module 104, the interpretation engine 106, and other components of the system 100 or 200.

In some aspects, the computing system may include additional hardware or software components, such as storage devices, memory units, or additional software modules. The computing system may also be configured in different ways, such as a standalone computer, a server in a client-server architecture, or a node in a distributed computing environment. The computing system may be implemented using various types of computing devices, such as desktop computers, laptop computers, servers, mainframes, or other types of computing devices.

The system described for automated tax return analysis can be adapted for various other use cases that involve complex data analysis, pattern recognition, and personalized recommendations. Here are a few examples of how this system could be applied in different domains:

In the healthcare sector, the system could be used for automated medical record analysis and treatment recommendation. The partial interpretation engine could process patient medical records from multiple visits or years, while the genAI module could compare the processed data to identify changes in health conditions over time. The knowledge store could contain medical guidelines and treatment protocols, which the system could cross-reference with the identified changes to detect potential health issues. The system could then determine appropriate treatment options based on the detected conditions and generate human-readable reports for healthcare providers.

In the financial services industry, the system could be adapted for automated investment portfolio analysis and optimization. The interpretation engine could process financial statements and investment data from various time periods, while the genAI module could compare the processed data to identify changes in investment performance and market trends. The knowledge store could contain investment strategies and market analysis, which the system could use to detect investment opportunities or risks. The system could then determine potential portfolio adjustments based on the detected situations and generate personalized investment recommendations for clients.

In the field of education, the system could be utilized for automated student performance analysis and personalized learning recommendations. The interpretation engine could process student academic records and assessment data from multiple semesters or years, while the genAI module could compare the processed data to identify changes in academic performance and learning patterns. The knowledge store could contain educational standards and learning strategies, which the system could cross-reference with the identified changes to detect areas for improvement or advanced study. The system could then determine appropriate learning resources and interventions based on the detected situations and generate personalized learning plans for students and educators.

For clarity, in the healthcare sector example, the method described in FIG. 3 could be adapted for automated medical record analysis and treatment recommendation. The process would begin with step 302, where healthcare providers or patients upload partial medical records for two or more years or visits to the system. These records may include various types of medical data such as diagnoses, treatments, lab results, and patient-reported outcomes.

In step 304, the “Partial Medical Record” Interpretation Engine would process and structure the data from the uploaded records. This engine may use advanced NLP algorithms to interpret unstructured medical notes, standardize medical terminology, and extract relevant health information from various types of medical documents.

Moving to step 306, the genAI system would compare the structured medical data from the two or more years or visits. This comparison may identify changes in health conditions, treatment efficacy, medication adjustments, and other relevant health trends over time. The AI system may generate a comprehensive health profile that highlights significant changes and potential areas of concern.

In step 308, the knowledge store, which in this case would contain medical guidelines, treatment protocols, and up-to-date research findings, would cross-reference the identified changes with current medical knowledge. This step may involve detecting potential health issues, assessing the effectiveness of ongoing treatments, and identifying opportunities for preventive care or lifestyle interventions.

The process continues to step 310, where the system generates a comprehensive, human-readable report based on the analysis. This report may include a summary of the patient's health trends, identified health issues, and suggested treatment options or interventions. The report may be tailored for both healthcare providers and patients, providing clear explanations and actionable recommendations.

In step 312, a feedback Loop captures actions taken by healthcare providers based on the system's recommendations. This feedback may include the effectiveness of suggested treatments, accuracy of detected health issues, and overall patient outcomes. The system uses this feedback to refine its algorithms, improving its ability to analyze medical records and provide accurate, personalized health recommendations over time.

While the foregoing is directed to example embodiments described herein, other and further example embodiments may be devised without departing from the basic scope thereof. For example, aspects of the present disclosure (e.g., modules) may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the disclosed example embodiments, are example embodiments of the present disclosure.

It will be appreciated by those skilled in the art that the preceding examples are not limiting. It is intended that permutations, enhancements, equivalents, and improvements thereto are apparent to those skilled in the art upon a reading of the specification and a study of the drawings are included within the true spirit and scope of the present disclosure. It is therefore intended that the following appended claims include such modifications, permutations, and equivalents as fall within the true spirit and scope of these teachings.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed:

1. A system for automated tax return analysis, comprising:
a partial tax return interpretation engine configured to execute natural language processing to process tax return data from two or more tax years;
a generative artificial intelligence (genAI) module configured to compare the processed tax return data and identify changes between the two or more tax years;
a knowledge store containing tax rules;
a tax situation identifier configured to cross-reference the identified changes with the tax rules to detect tax situations;
a deductions identifier configured to determine tax deductions based on the detected tax situations; and
a report generator configured to produce a report of the detected tax situations and the tax deductions.

2. The system of claim 1, wherein the partial tax return interpretation engine comprises natural language processing algorithms configured to interpret unstructured tax return data.

3. The system of claim 2, wherein the natural language processing algorithms comprise at least one of Bidirectional Encoder Representations from Transformers (BERT) or Generative Pre-Trained Transformer (GPT).

4. The system of claim 1, wherein the genAI module comprises generative models configured to generate comparisons of the tax return data.

5. The system of claim 4, wherein the generative models comprise at least one of Generative Adversarial Networks (GANs) or Variational Autoencoders (VAEs).

6. The system of claim 1, wherein the knowledge store comprises a vector store for storing the tax rules, enabling faster retrieval and more precise identification of the tax situations.

7. The system of claim 1, further comprising a feedback loop configured to capture user actions and refine the system based on the captured actions.

8. The system of claim 7, wherein the feedback loop incorporates reinforcement learning techniques to improve performance of the system on a subsequent tax return analysis.

9. The system of claim 1, wherein the report generator is configured to provide personalized tax return comparisons highlighting the changes and suggested optimization steps.

10. The system of claim 1, further comprising a data ingestion module configured to retrieve and process tax-related information from external sources.

11. A method for automated tax return analysis, comprising:
executing, by a partial tax return interpretation engine, natural language processing to process tax return data from two or more tax years;
comparing, by a generative artificial intelligence (genAI) module, the processed tax return data and identifying changes between the two or more tax years;
storing, in a knowledge store, tax rules;
cross-referencing, by a tax situation identifier, the identified changes with the tax rules to detect tax situations;
determining, by a deductions identifier, tax deductions based on the detected tax situations; and
producing, by a report generator, a report of the detected tax situations and the tax deductions.

12. The method of claim 11, wherein the partial tax return interpretation engine comprises natural language processing algorithms configured to interpret unstructured tax return data.

13. The method of claim 12, wherein the natural language processing algorithms comprise at least one of Bidirectional Encoder Representations from Transformers (BERT) or Generative Pre-Trained Transformer (GPT).

14. The method of claim 11, wherein the genAI module comprises generative models configured to generate comparisons of the tax return data.

15. The method of claim 14, wherein the generative models comprise at least one of Generative Adversarial Networks (GANs) or Variational Autoencoders (VAEs).

16. The method of claim 11, wherein the knowledge store comprises a vector store for storing the tax rules, enabling faster retrieval and more precise identification of the tax situations.

17. The method of claim 11, further comprising capturing, by a feedback loop, user actions and refining the method based on the captured actions.

18. The method of claim 17, wherein the feedback loop incorporates reinforcement learning techniques to improve performance of the method on a subsequent tax return analysis.

19. The method of claim 11, wherein the report generator provides personalized tax return comparisons highlighting the changes and suggested optimization steps.

20. The method of claim 11, further comprising retrieving and processing, by a data ingestion module, tax-related information from external sources.
